(19) United States
(12) Patent Application Publication
(10) Pub. No.: US 2017/0364876 A1
(43) Pub. Date: Dec. 21, 2017

(54) SYSTEMS AND METHODS FOR MANAGING SHARING ECONOMY PAYOUTS

(71) Applicant: VISA INTERNATIONAL SERVICE ASSOCIATION, San Francisco, CA (US)

(72) Inventors: Dong Soon Denis Kang, Singapore (SG); Augustine Samuel Victor, Singapore (SG); Krishna Nellutla, Singapore (SG); Samanth Yadav Krishnamurthy, Singapore (SG); Rama Rao Dutta, Singapore (SG)

(21) Appl. No.: 15/186,035

(22) Filed: Jun. 17, 2016

(51) Int. Cl. G06Q 20/10; G06Q 30/06; G06Q 20/14

(52) U.S. Cl. CPC G06Q 20/102; G06Q 20/145; G06Q 30/0605

(57) ABSTRACT

A method for managing payouts to parties to a transaction, including receiving a customer request for a service transaction, and transmitting the customer request to at least one service provider terminal. The method includes receiving a service completion message from the at least one service provider terminal. The method includes determining that at least one surge parameter applies to the service transaction. The method includes determining a surge payout split based on the determination that at least one surge parameter applies to the service transaction and generating a surge payout split request based on the surge payout split. The method includes transmitting the surge payout request to a payment network server, and receiving an account update from the payment network server, the account update reflecting the surge payout split.

### FIELD OF THE INVENTION

The invention relates to systems and methods for processing and distributing payouts for services. Among other fields and applications, the invention has utility in simplifying and improving payments among multiple parties to a shared economy transaction.

### BACKGROUND

The onset of the digital economy and mobile technology continues to expand the marketplace and includes many services categorized in the so-called “collaborative economy” or “sharing economy.” Such markets may involve peer-to-peer based sharing of access to goods and service, such ride-sharing (e.g., Uber or Lyft) or residence-sharing (e.g. Airbnb), coordinated through online or mobile device-based services. Service providers can register with the coordinating entities and offer their services to customers to patronize their business through the coordinating entity. To learn of service providers, customers may browse the websites or sign up to periodically receive alerts. When a customer selects a particular service provider or, in the case of ride sharing, a service provider is automatically selected for the customer based on timing or location, the customer and the individual service provider may be brought together to initiate service. Typically, once the service has been provided to the customer, a payment may be made through the coordinating entity, with at least a portion of the payment going to the coordinating entity (e.g., Uber), and another portion of the payment going to at least one service provider (e.g., an Uber-registered driver).

In certain markets and under certain circumstances, variable pricing for services may be implemented by the coordinating entity. For example, during a major sporting event in a particular city, a ride-sharing coordinating entity, such as Uber, may increase prices to take advantage of the increased demand for vehicle transportation at the time or place of the sporting event, and to provide incentive for service providers, such as Uber-registered drivers, to offer their services and increase the number vehicles available for hire. Such “surge” pricing may result in additional profits for both the coordinating entity and the service providers registered with that entity. Traditionally, however, it may take days or even weeks for the service providers to receive their share of the service fees paid by customers. This may be exacerbated even further when the coordinating entity or the service provider are in different countries or operating using various currencies.

As a result of the foregoing, a need exists to provide coordinating entities in the sharing economy with better and faster payment mechanisms for registered service providers.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 shows a block diagram illustrating example aspects of a system for processing and distributing payouts generated through sharing economy services in accordance with example embodiments.

FIG. 2 illustrates an example signaling flow diagram showing communications within a system for processing and distributing payouts generated through sharing economy services in accordance with example embodiments.

FIG. 3 illustrates a flow chart of a process for distributing payouts generated through sharing economy services in accordance with example embodiments.

FIG. 4 illustrates another example signaling flow diagram showing communications within a system for processing and distributing payouts generated through sharing economy services in accordance with example embodiments.

FIG. 5 illustrates a flow chart of a another process for distributing payouts generated through sharing economy services in accordance with example embodiments.

FIG. 6 illustrates a dashboard graphical user interface (GUI) in accordance with example embodiments.

FIG. 7 illustrates another dashboard graphical user interface (GUI) in accordance with example embodiments.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a computer-implemented method for managing payouts to parties to a transaction. The method includes receiving, via a digital communication network, a customer request for a service transaction, and transmitting, via the digital communication network, the customer request to at least one service provider terminal. The method includes receiving, via the digital communication network, a service completion message from the at least one service provider terminal. The method includes determining, via one or more processors, that at least one surge parameter applies to the service transaction. The method includes determining, via the one or more processors, a surge payout split based on the determination that at least one surge parameter applies to the service transaction and generating, via the one or more processors, a surge payout split request based on the surge payout split. The method includes transmitting, via a payment network, the surge payout request to a payment network server, and receiving, via the payment network, an account update from the payment network server, the account update reflecting the surge payout split.

In another embodiment, the disclosure describe a computer-implemented method for managing payouts to parties to a transaction. The method includes receiving, via a payment network, transaction information relating to a service transaction provided by at least one service provider, and transmitting, via the payment network, a request for surge parameters to a service coordinator server, where the request for surge parameters being based on the transaction information. The method includes receiving, via the payment network, at least one surge parameter from the service coordinator server. The method includes determining, via one or more processors, a surge payout split based on the at least one surge parameter. The method includes executing a payout split based on the surge payout split. The payout split includes directing payments to an account associated with the at least one service provider. The method also includes transmitting, via the payment network, an account update reflecting the payout split.

In another embodiment, the disclosure describes an apparatus comprising at least one processor, and at least one memory storing computer executable instructions that, when executed by the at least one processor, cause the apparatus at least to perform the steps of receiving a customer request for a service transaction, transmitting the customer request to at least one service provider terminal, and receiving a service completion message from the at least one service provider terminal. The instructions also cause the apparatus to perform the steps of determining, via the at least one processor, that at least one surge parameter applies to the service transaction and determining, via the at least one processor, a surge payout split based on the determination that at least one surge parameter applies to the service transaction. The instructions also cause the apparatus to perform the steps of generating, via the at least one processor, a surge payout split request based on the surge payout split and transmitting, via a payment network, the surge payout request to a payment network server. The instructions also cause the apparatus to perform the steps of receiving, via the payment network, an account update from the payment network server, the account update reflecting the surge payout split.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

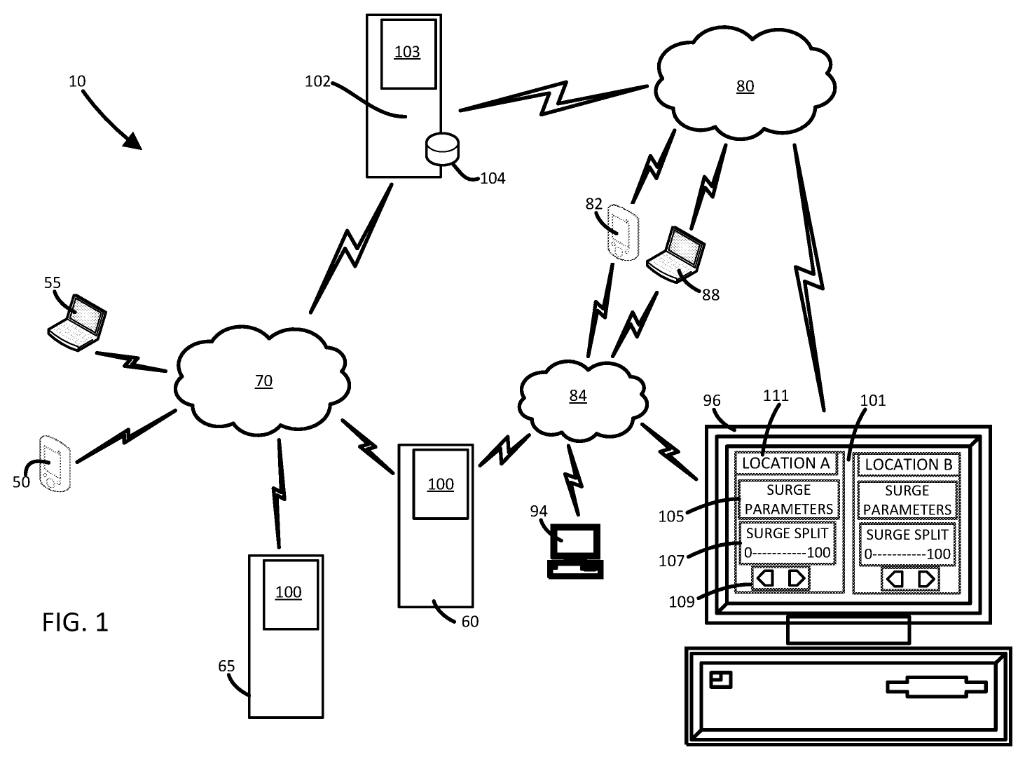

FIG. 1 illustrates a block diagram of a system 10 for processing and distributing payouts generated through sharing economy services. System 10 may include one or more client terminals 50, 55, one or more service coordinator servers 60, 65, one or more payment network servers 102, one or more service provider terminals 82, 88, and one or more servicer coordinator user terminals 94, 96. Networks 70, 80, 84, and 92 are shown interconnecting various components. Networks 70, 80, and 84, be the Internet, WAN, LAN, Wi-Fi, other computer network (now known or invented in the future) as well as any combination of the foregoing. It should be understood by those of ordinary skill in the art having the present specification, drawings, and claims before them that networks 70, 80, and 84 may connect the various components over any combination of wired and wireless conduits, including copper, fiber optic, microwaves, and other forms of radio frequency, electrical and/or optical communication techniques. It should also be understood that each individual network may be connected to any of networks 70, 80, and 84 differently. The interconnections between devices in system 10 are examples. Any device depicted in FIG. 1 may communicate with any other device via one or more of the networks 70, 80, and 84.

System 10 may include additional devices and networks beyond those shown. Further, the functionality described as being performed by one device may be distributed and performed by two or more devices. Multiple devices shown in FIG. 1 may also be combined into a single device, which may perform the functionality of the combined devices.

Servers 60, 65, and 102 may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. Servers 60, 65, and 102 may be running on any one of many operating systems including, but not limited to WINDOWS, UNIX, LINUX, MAC OS, or Windows (XP, VISTA, etc.). It is contemplated, however, that any suitable operating system may be used for the present invention. Servers 60, 65, and 102 may be one or may be a cluster of web servers, which may each be LINUX based and supported by a load balancer that decides which of the cluster of web server should process a request based upon the current request-load of the available server(s).

Terminals 50, 55, 82, 88, 94, and 96 may be general purpose computers that may have, among other elements, a microprocessor (such as from the Intel Corporation or AMD); volatile and non-volatile memory; one or more mass storage devices (i.e., a hard drive); various user input devices, such as a mouse, a keyboard, or a microphone; and a video display system. Examples of terminals include tablets, mobile phones, smart phones, computers, laptops, and the like. In one aspect, the general-purpose computer may be controlled by the WINDOWS (XP, VISTA, etc.) operating system. It is contemplated, however, that the present system would work equally well using a MACINTOSH computer or even another operating system such as a UNIX, LINUX, MAC OS, or a JAVA based operating system, to name a few.

Terminals 50, 55, 82, 88, 94, and 96 may operably connect to servers 60, 65, and 102, respectively, via one of many available internet browsers including, but not limited to, Microsoft's Internet Explorer, Apple's Safari, and Mozilla's Firefox. Via any of networks 70, 80, or 84, the end users may access the system 10 with, for example, an http-based or https-based website, although other graphical user interfaces can be used with the present system. For example, applications designed specifically for use in the present system may provide a user interface to monitor and participate in the disclosed system. The information entered by a user, service coordinator employee, or service provider via terminals 50, 55, 82, 88, 94, and 96 may be encrypted before transmission over a network for security. There are several commercially available encryption programs or algorithms available including, but not limited to, PC1 Encryption Algorithm, TrueCrypt, a Symantec encryption program, Blowfish, and Guardian Edge.

Service coordinator servers 60, 65 may provide a digital marketplace through which service providers may offer deals or otherwise list their availability for providing services. In an example, service coordinators 60, 65 may host websites or applications that may be accessed by client terminals 50, 55 via network 70. Likewise, service providers, using service provider terminals 82, 88, may also access applications provided by the service coordinator 60 via a service coordinator network 84. The service coordinators' websites or applications may list services that are available from the service providers registered with the specific service coordinator. For example, in some embodiments, the service coordinator may be a ride sharing service affiliated with drivers (i.e., service providers) registered with the ride sharing service coordinator. The drivers may access their individual accounts at the service coordinator server 60 via their terminals 82, 88 using the service coordinator network 84. The drivers 82, 88 may indicate to the service coordinator server 60 that they are offering driving services. In some embodiments, the drivers may post parameters, such as prices, locations, or times at which they are willing to drive a customer. In other embodiments, the prices and other parameters may be determined by the service coordinator, and may be determined automatically by the service coordinator server 60 based on factors such as weather, special events in the area, demand for drivers, etc. If a user would like to enlist a driver's services, a client terminal 50, 55 may be used to access the service coordinator's application on the service coordinator server 60 via network 70 and request driver services generally or, in some embodiments, for a specific driver. The driver may then receive the request, agree to it by inputting an indication of such agreement via the driver's terminal 82, 88, and proceed to perform the requested driving service for the user. Once the driver has completed the requested service for the user, the user may submit payment to the service coordinator, which may then be split or otherwise dispensed via the payment network server 102 and payment network 80, as described in further detail below. Of course, the service coordinators, in varying embodiments, may be coordinating any kind of sharing economy service or product, and is not limited to ride sharing services as described in the above example.

To enable service coordinators to coordinate services and payments between service providers and users of those services, the service coordinator server 60 may monitor transactions between users and service providers. The payments for such transactions may be monitored and managed by a payout management engine 100 that may be running on the service coordinator server 60 and accessible at the terminals 94, 96 via the service coordinator network 84. As discussed in greater detail below, the payout management engine 100 may be used by the service coordinator to distribute payouts associated with services provided by service providers through the service coordinator either automatically or manually using terminals 94, 96.

In some embodiments, service coordinator server 60 may include specifically programmed computer hardware performing the functions described herein as associated with the payout management engine. Examples of the specifically programmed computer hardware include a display/report generator, an analytical engine, a payout split generator, and memory. In some examples, the specifically programmed computer hardware may be hardwired to perform functionality described herein, may include one or more specifically programmed software modules executing specialized computer instructions to perform functionality described herein, and/or combinations thereof.

In some embodiments, the payment network server 102 may be connected to the service coordinator server 60, the service provider terminals 82, 88, and the service coordinator terminals 94, 96 via one or more networks, such as the digital communications network 70, service coordinator network 84, and/or the payment network 80. The payment server 102 may include a direct payment engine 103 through which payment accounts for registered users can send or receive funds. For example, a user having an account with the direct payment engine 103 may register one or more payment cards or banking accounts with the direct payment engine, providing permission for the direct payment engine to selectively send or receive funds from those registered accounts. Specifically, in some embodiments, service providers may have accounts with registered with the direct payment engine 103 accessible with service provider terminals 82, 88 via the payment network 80, and the service coordinators may have accounts registered with the direct payment engine accessible from the service coordinator server 60, 65 or service coordinator terminals 94, 96.

In some embodiments, payment network server 102 may include specifically programmed computer hardware performing the functions described herein. Examples of the specifically programmed computer hardware include a display/report generator, an analytical engine, and memory. In some examples, the specifically programmed computer hardware may be hardwired to perform functionality described herein, may include one or more specifically programmed software modules executing specialized computer instructions to perform functionality described herein, and/or combinations thereof. The payment network server 102 may also include a database 104 or other storage device storing user account data records that include data on at least some accounts and transactions that have been authorized. Database 104 may be any suitable database or databases including, but not limited to, SQL databases (by Microsoft and others), Oracle databases, 4^{th} Dimension databases, InterBase databases, and Apache databases. While depicted as a single database, it should be understood by those of ordinary skill in the art having the present specification, drawings, and claims before them that the database 104 may be stored in multiple locations and across multiple pieces of hardware, including but not limited to storage in the cloud (i.e., a set of virtual storage areas and systems that expand and contract with use without requiring the manual provisioning or deprovisioning of physical hardware by the administrator). In view of the sensitivity and/or commercial significance of most of the data stored in the databases they are preferably secured in an attempt to minimize the risk of undesired disclosure of viewer information to third parties. The databases may be standard relational database systems such as those available from Oracle.

In many sharing economy markets, multiple parties to a given transaction may divide, or “split” the customer payment for the transaction between the parties. For example, in a ride sharing scenario, the customer's payment may be “split” between the service coordinator (e.g., Uber or Lyft) and the service provider (e.g., a driver). The “payout split” may refer to the amount or percentage of the customer payment that is distributed to, respectively, the service coordinator, the service provider, or any other party to a specific transaction. In some embodiments, the payout split may apply to multiple service coordinators, multiple service providers, or other parties associated with providing service. For example, a customer payment for lodging may be split between the service coordinator, the owner of the particular space used for lodging, and a manager employed by the owner to manage and direct the use of the space. Depending on agreements between the service coordinator and the service provider, and/or between the service provider and other associated parties, portions of the customer payment may be split in varying ways to some or all of the parties.

In some embodiments, the service coordinator and the service providers who are registered to provide service through the service coordinator may agree upon a “standard payout split” that may apply under predetermined “standard” conditions. These conditions may be based on any number of split parameters, such as time of day, day of the week, weather, time of year, volume of demand, special events in the geographic area, etc. Thus, the parties receiving payment for a service economy transaction may have previously agreed on a particularly percentage of the received payment going to each party, or that a minimum amount for each transaction goes to a service coordinator, and the remainder goes to the service provider(s). Of course, the number of ways in which the service providers and service coordinators may determine the payout splits is virtually limitless. In some embodiments, the payout split may not be based on a previous agreement, but instead be negotiated on a per-transaction basis. Thus, in block 218, when the payout management engine 100 determines the standard payout split for the transaction, the payout management engine may be referring to a predetermined payout split agreed upon by the parties prior to the transaction.

In some embodiments, the parties to a transaction may also have agreed upon different payout splits that apply under non-standard conditions, i.e., “surge” payout splits. In some embodiments, surge payout splits may be different than the standard payout splits and may be implemented based on predetermined surge parameters. For example, in some embodiments, surge payout splits in the existence of certain surge parameters, such as during rush hour, near a large sporting event or concert, during high customer volumes, during inclement weather, or other conditions under which the service coordinator and service providers have agree to depart from the standard payout split. In some embodiments, the presence of surge parameters may also trigger an increase in the prices charged for the particular service, i.e., surge pricing. Surge pricing and surge payout splits may apply based on the same parameters; however, it is contemplated that each may alternatively be triggered separately.

In some embodiments, surge payout splits may differ from standard payout splits such that the amounts or percentages of the payout splits may cause a greater incentive to provide a given service when the surge parameters are present. For example, during rush hour in a congested city, or in the vicinity of a large sporting event, the surge payout splits may increase the percentage of the payout directed to the service provider as compared to the standard split. So, in one example, the standard payout split may be 50% to the service coordinator and 50% to the service provider, and the surge payout split may be 35% to the service coordinator and 65% to the service provider. Of course, the payout split may be more complicated, such as varying percentages after a minimum amount paid to the service coordinator. Additionally, in some embodiments, the surge payout splits may be static, i.e., an single alternative to the standard payout splits when predetermined surge parameters are present. In other embodiments, the surge payout splits may be dynamic, i.e., the surge payout split may be variable and may increase or decrease substantially in real time in response to fluctuating split or surge parameters. In some embodiments, the current payout split, be it standard or surge, may be available to the service providers via their respective terminals 82, 88 and may be available to the service coordinators via terminals 94, 96. In such embodiments, the service providers may monitor the levels of the payout split in order to decide whether to accept a request to provide services at a given date or time.

In some embodiments, the split parameters may be measured in any suitable way and provided to the payout management engine 100 to automatically determine the applicable payout split at any given time or location. For example, customer volume may be measured in real time to determine when the volume exceeds the predetermined standard level. In some embodiments, the use of certain surge payout splits may be manually scheduled in advance based on a known upcoming event. For example, if a service coordinator knows that a large sporting event will be occurring at a particular date and time, the service coordinator may implement surge payout splits during a time period and for a geographical region corresponding to the event.

In some embodiments, the payout management engine 100 may at least one graphical user interface (GUI) 101 through which a service coordinator or service provider may monitor or interact with the payout management engine. One example of a GUI for monitoring surge payout splits is shown displayed on terminal 96 in FIG. 1. The graphical user interface 101 may include a window or graphic with location data 111, surge parameter data 105, surge split data 107, and split input buttons 109. Of course, GUI 101 is merely one embodiment of the payout management engine GUI, and other windows with other graphics displaying other data are contemplated herein. The GUI 101 may display surge data for various locations at once, or may allow a user to select a specific location to display. The GUI 101 in FIG. 1 includes data for two locations, Location A and Location B. The surge parameters 105 shown in the GUI 101 may include the levels or other quantitative or qualitative measures that the payout management engine 100 may use to determine whether or not to implement surge pricing or surge payout splits, and at what levels. The surge split data 107 may indicate the amount of the current surge payout split. In the illustrated embodiment, the surge split 107 is indicated by a percentage between 0% and 100% of the share of the payout that may go to the user for a given transaction. In the illustrated embodiment, the GUI 101 is displayed on the service coordinator terminal 96, but it is contemplated that a similar GUI could be displayed on a service provider terminal 82, 88 and show the surge payout split from the service provider's perspective. In some embodiments, the GUI 101 may also include split input buttons 109 that may be used to manually adjust the payout split.

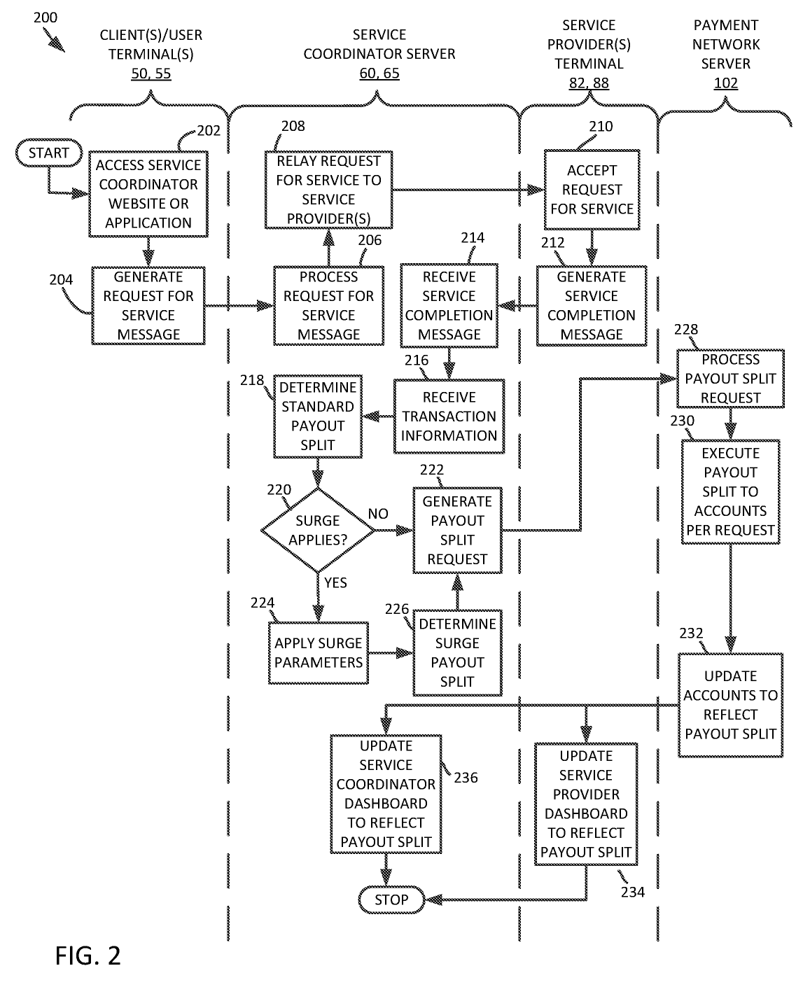

FIG. 2 illustrates an example signaling flow diagram 200 showing communications within system 10 for managing a sharing economy transaction and the payouts and payout splits associated with the transaction. In an example, a customer may, in block 202, use a client terminal 50 to access a service coordinator website or application from service coordinator server 60. The client terminal 50 may be a computer, a smart phone, a tablet computer, or other device for communicating via a network. The service coordinator server 60 may be a webserver or other device configured to provide a website or network-connected application to the client terminal 50. The customer may select a particular service they would like provided, and may provide payment information. Payment information may include, for example, a payment number (e.g., credit card number, a 16 digit personal account number (PAN), a near field communication (NFC) credential, etc.), billing address of the customer, and a card verification value (e.g., CVV2 number) for a credit card. In some embodiments, the service coordinator server 60 may include a database of payment information for each customer, and may request payment based on the stored payment information for that customer. In some embodiments, the customer payment information may not be provided until after the selected service has been provided. In block 204, the client terminal 50 may generate a request for service corresponding to the service selected by the customer, and may transmit a request for service message to the service coordinator server 60 over the digital communication network 70.

Subsequent to receipt of the request for service message, the service coordinator server 60 may, in block 206, process the request for service message. The service coordinator server 60 may, in block 208, generate and transmit the request for service to one or more service provider terminals 82, 88, depending on whether the requested service is for a specific service provider (e.g., a specific hotel) or a more general service request (e.g., any available room or driver). In block 210, the service provider may use a service provider terminal 82, 88 to accept a request for service received from the service coordinator server 60. Upon accepting the request, the service provider may then proceed to provide the requested service to the customer, e.g., picking up the customer and driving him/her to the requested location, or providing access to a hotel room or other lodging for the agreed-upon time period. Once the service has been completed, the service provider terminal 82, 88 may be used, in block 212, to generate a service completion message and transmitting the service completion message to the service coordinator server 60 via the service coordinator network 84 or another suitable communication network.

In block 214, the service coordinator server 60 may receive the service completion message, indicating that the requested service has been provided and that payment and payout procedures may be initiated. In block 216, the service coordinator server 60 may receive transaction information associated with the service provided to the customer by the service provider. In some embodiments, the transaction information may be included in the service completion message received from the service provider terminal 82, 88. In some embodiments, the transaction information may already be available on the service coordinator server 60 having been cached or otherwise stored upon receiving the initial request for service. In such embodiments, the service coordinator server 60 may confirm that the service described in the service completion message matches the service requested in the request for service.

Based on the transaction information, in block 218, the service coordinator server 60 may initiate the payout management engine 100 to determine the standard payout splits appropriate for the given transaction. As described above, the standard payout split may be predetermined by the service coordinator, may be agreed upon in advance between the service coordinator and the service provider, or may be determined upon the service provider's acceptance of the service request. Once, the standard payout split is determined, in some embodiments, payout management engine 100 may determine, in block 220, whether certain surge parameters exist that may warrant implementation of a surge payout split either on top of the standard split or instead of the standard split. If no surge parameters are present, the payout management engine 100 may, in block 222, generate a payout split request based on the standard payout split. If, however, the payout management engine 100 determines that surge parameters are present, the payout management engine may use the surge payout split in place of the standard payout split. In some embodiments, however, the payout management engine 100 may employ the surge payout splits separate and in addition to the standard payout split. In any event, in block 224, the payout management engine 100 may apply the surge parameters and, in block 226, determine a surge payout split based on the surge parameters. A payout split request may then be generated in block 222 reflecting the surge payout split. The payout split request may be transmitted to the payment server 102 via the payment network 80.

In an example, payment network server 102 may be operated by a financial services corporation that facilitates electronic funds transfers. An example of such a financial services corporation is VISA Inc. In another example, a credit card issuer or other banking entity could deploy the payment network server 102 for tracking purchases of its cardholders or account holders. Additionally, the service coordinator may have an agreement with an acquirer that handles their payment processing. An acquirer server, instead of a service coordinator server, may communicate with payment network server 102.

Payment network server 102 may, in block 228, process the payout split request using the direct payment engine 103. Processing of the payout split request may include, among other things, determining if the parties to receive payouts have accounts associated with the entity operating the payment network server 102 and available to the direct payment engine 103. For example, a service provider may have previously registered account information accessible on the server database 104. In such embodiments, payouts associated with services provided through the service coordinator may be readily directed into the service providers account. Further, payment network server 102 may also communicate with a server of an issuer as part of an authorization process. Payment network server 102 may also facilitate funds transfers between a bank associated with the customer and a bank associated with the service coordinator.

Once the payout split request is processed and the parties' accounts are identified and authorized, the direct payment engine 103 on payment network server 102 may, in block 230, execute the payout split by directing the proper amounts of funds into the accounts associated with the particular parties to a transaction. For example, if a surge payout split applies on a transaction for $100 and splits payouts between the service coordinator at 15% and the service provider at 85%, the direct payment engine 103 may direct $15 into an account associated with the service coordinator and $85 into an account associated with the service provider. In some embodiments, the service coordinator's account may initially hold all the funds received from a customer associated with a particular service provided. In such embodiments, the direct payment engine 103 may direct payments from the service coordinator's account into the service providers account or accounts. In such embodiments, because the service provider and the service coordinator already have accounts registered with the entity controlling the payment network server 102 and accessible through the direct payment engine 103, the service provider may receive the funds from performing the service immediately, or at least relatively soon after the service is performed. In some embodiments the funds are received within less than ten minutes of completions, or within one hour, or within one day of completion.

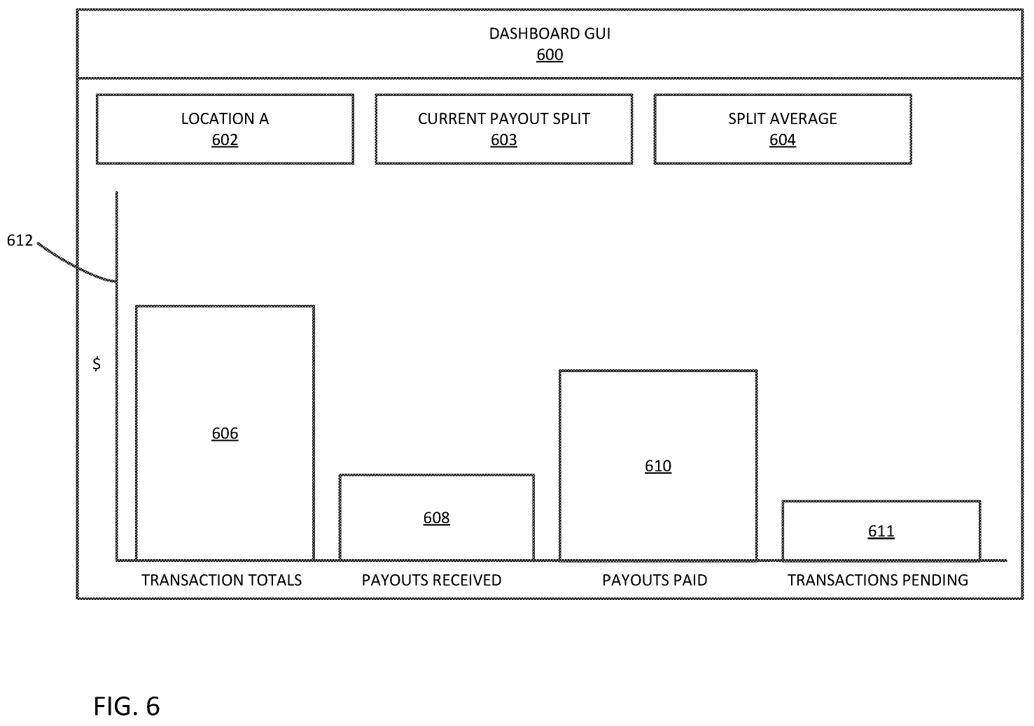

In block 232, the direct payment engine 103 may update the funds in the accounts associated with the payout split. For example, if the service provider receives $85 for providing a service, the account associated with that service provider may include those funds. In some embodiments, the payment network server 102 may transmit the updates to one or both of the service provider terminal(s) 82, 88 in block 234 and/or the service coordinator server 60 in block 236. A GUI for the payout management engine 100 accessible from either the service coordinator terminals 94, 96 or the service provider terminals 82, 88 may display, in real time or in near real time, the updated fund levels as a result of the payout split. FIG. 6 illustrates an embodiment of a dashboard GUI 600 that may be accessed by either the service coordinator terminal 94, 96 to monitor payments and payout splits for a particular location or a group of locations. As shown, the dashboard GUI 600 may illustrate certain data that may be updated in real time or as updates from the payment network server 102 are received for each service transaction. In the illustrated embodiment, the dashboard GUI 600 includes location data 602, the current payout split 603, and split average 604. The location data 602 may refer to a geographic region in which a service coordinator may be operating. The location data 602 may be selectively changed to include different locations. The current payout split 603 may indicate the payout split currently being implemented in the selected location, and may change dynamically as the payout split changes in response to surge parameters. The split average 604 may indicate the average payout split over a select period of time, such as the last hour, day, month, year, etc. Alternatively, the split average 604 may indicate the average payout split for a selected time period in the past. The dashboard GUI 600 also includes graphical indicators for transaction totals 606, payouts receive 608, payouts paid 610, and transactions pending 611, plotted along a vertical axis 612. The transaction totals 606 may reflect the total amount of revenue received in payment for services. The payouts received 608 may indicate the funds received after the payout split has been executed by the payment network server 102, and the payouts paid 610 may indicate the funds paid to service providers or other parties after the payout split. The transactions pending 611 may indicate transactions that have been accepted by service providers, but that have not yet been completed. The levels displayed by the dashboard GUI 600 may fluctuate as additional updates are received from the payment network server 102. It is contemplated that the data displayed in the dashboard GUI 600 may be displayed in various ways and that other data may also be shown.

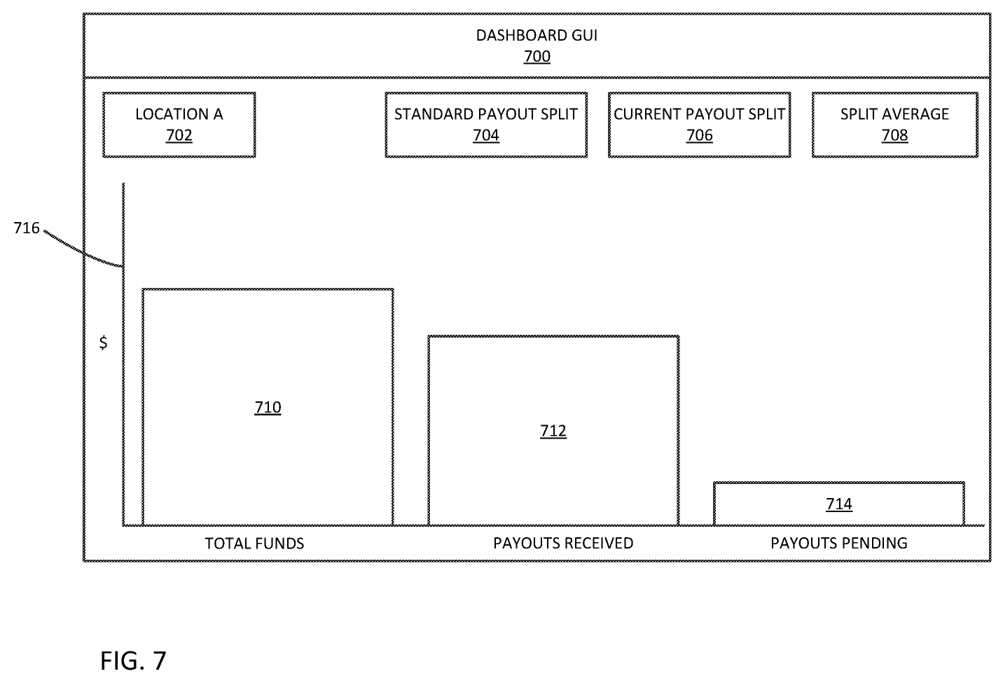

FIG. 7 illustrates an embodiment of a service provider dashboard GUI 700 that may be accessible to a service provider to monitor funds received from providing service associated with the service coordinator, and to monitor the conditions for providing services in a selected location at a given time or at a selected date or time. The dashboard GUI 700 may include location data 702 indicating the geographic location for which the data on the GUI applies. The dashboard GUI may also include the standard payout split 704 for that location, the current payout split 706 that may be the same as the standard or may differ depending on whether surge parameters apply, and the split average 708, which may be displayed for a selected time period. The GUI 700 may also include total funds 710, payouts received 712, and payouts pending 714 plotted along a vertical axis 716. The total funds 710 may indicate the total funds currently in the account associated with the service provider stored in the database 104 of the payment network server 102. The payouts received 712 may show the payouts that have been received for services rendered within the selected location and may be variable based on a certain time period. The payouts pending 714 may show the expected payout amounts to be received for service requests that have been accepted but not yet completed. The levels displayed by the dashboard GUI 700 may fluctuate as additional updates are received from the payment network server 102. It is contemplated that the data displayed in the dashboard GUI 700 may be displayed in various ways and that other data may also be shown.

In some embodiments, the service coordinator dashboard GUI 600 and the service provider dashboard GUI 700 are accessed with the terminals 82, 88, 94, 96 via the service coordinator server 60 and/or the payout management engine 100. In such embodiments, the funds data provided for display on the dashboard GUIs 600, 700 may be received in updates from the payment network server 102 or may access data from the database 104 on the payment network server 102 using an appropriate application program interface (API).

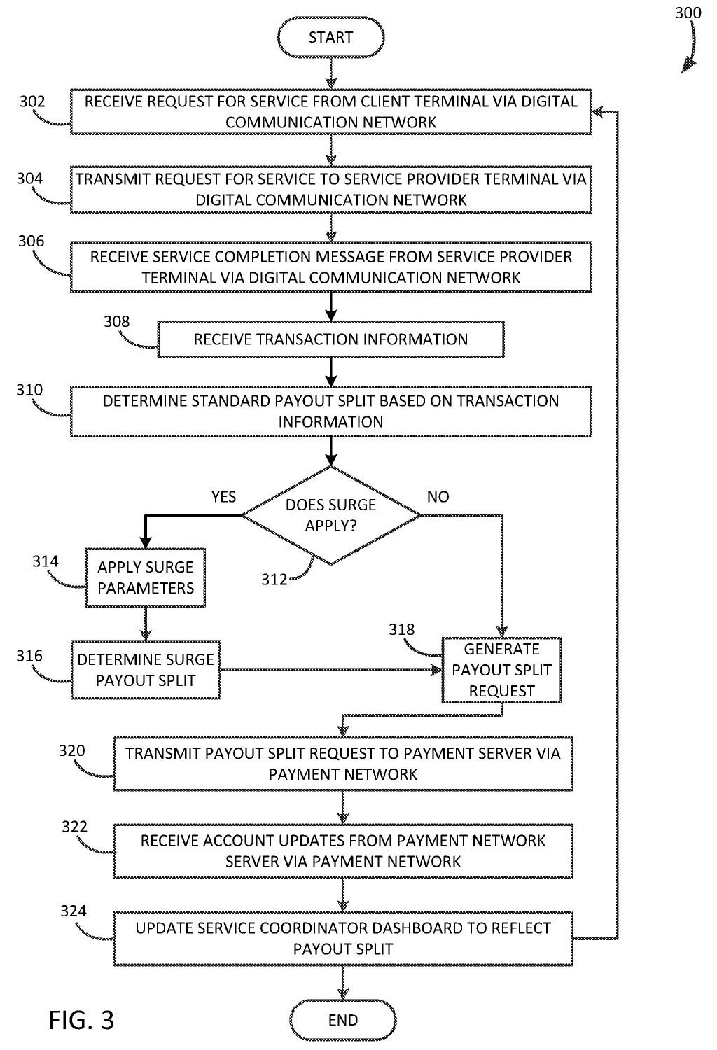

FIG. 3 shows a flow diagram 300 of a method for managing a sharing economy transaction and the payouts and payout splits associated with the transaction in accordance with example embodiments. The flow diagram may be implemented by a system or apparatus, such as, for example, service coordinator server 60. Each of the steps shown in the flow diagram may be repeated one or times, one or more of the steps may be modified, and one or more of the steps may be omitted. Unless otherwise noted or is plainly required by the context, the particular ordering of the blocks may also be modified. The method may be stored on a non-transitory computer readable medium as computer executable instructions. The computer executable instructions, when executed by at least one processor, may cause at least one computer or other device to perform the method one or more times. The flow diagram may begin at block 302.

In block 302, the method may include receiving a request for service from a client terminal via a digital communication network. In an example, with reference to FIGS. 1-2, service coordinator server 60 may receive request for service messages (e.g., via a service coordinator website or application) from a client terminal 50, 55. In block 304, the method may include transmitting the request for service to at least one service provider terminal via a digital communication network. In an example, with reference to FIGS. 1-2, service coordinator server 60 may extract certain service request data and payment information (e.g., credit card numbers) from each of the requests for service for tracking, reference, authorization or identification purposes.

In block 306, the method may include receiving a service completion message from a service provider terminal once the requested service has been completed, and in block 308, receive transaction information associated with the completed service. In an example, service coordinator server 60 may receive a message from the service provider terminal 82, 88 via the service coordinator network 84 indicating that the service requested in block 302 has been completed. The transaction information may also be received as part of the completion message. In an example, the transaction information may include the identity or registered ID of the service provider, the identity or user ID of the customer served, a total transaction amount, the date/time the service was requested, the duration of the service, and the date/time the service was completed.

In block 310, the method may include determining the standard payout split based on at least in part on the transaction information. In an example, with reference to FIGS. 1-2, the payout management engine 100 may determine the standard split that may have been previously agreed upon between the particular service provider identified in the transaction information and the service coordinator. In block 312, the method may include determining whether surge parameters apply to the transaction. In an example, the service coordinator server 102 may reference the current split parameter conditions to determine whether those conditions fall outside of those predetermined standard conditions If not, the payout management engine 100 may, in block 318, generate a payout split request based solely on the standard payout split. If surge parameters are present, the payout management engine 100 may, in block 314, apply the surge parameters to determine, at block 316, the surge payout split for the transaction. The payout management engine 100 may then generate a payout split request that includes the surge payout split.

In block 320, the method may include transmitting the payout split request to the payment network server 102 via the payment server network 80. In an example, the payout split request may identify the parties to the transaction who are to receive portions of the payout split, and the mount of the transaction to direct into the accounts of each individual party. In block 322, the service coordinator server 60 may receive account updates from the payment network server 102 that reflect the updated payout split. In block 324, the payout management engine 100 on the service coordinator server 60 may updated the service coordinator dashboard GUI to reflect the most recent payout split or the most recent account information.

The method in FIG. 3 may end, may repeat one or more times, or may return to any of the preceding blocks.

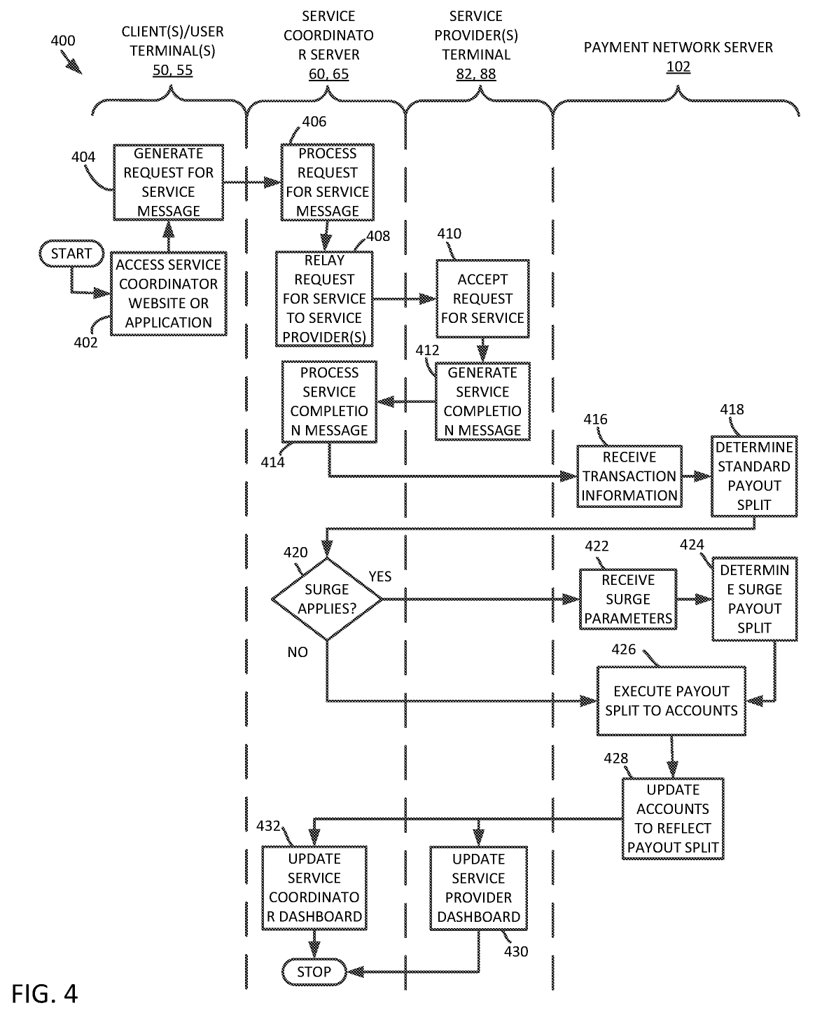

FIG. 4 illustrates another example signaling flow diagram 400 showing communications within system 10 for managing a sharing economy transaction and the payouts and payout splits associated with the transaction. Similar to the method in FIG. 2, a customer may, in block 402, use a client terminal 50 to access a service coordinator website or application from service coordinator server 60. The customer may select a particular service they would like provided, and may provide payment information. In block 404, the client terminal 50 may generate a request for service corresponding to the service selected by the customer, and may transmit a request for service message to the service coordinator server 60 over the digital communication network 70.

Subsequent to receipt of the request for service message, the service coordinator server 60 may, in block 406, process the request for service message. The service coordinator server 60 may, in block 408, generate and transmit the request for service to one or more service provider terminals 82, 88, depending on whether the requested service is for a specific service provider (e.g., a specific hotel) or a more general service request (e.g., any available room or driver). In block 410, the service provider may use a service provider terminal 82, 88 to accept a request for service received from the service coordinator server 60. Upon accepting the request, the service provider may then proceed to provide the requested service to the customer, e.g., picking up the customer and driving him/her to the requested location, or providing access to a hotel room or other lodging for the agreed-upon time period. Once the service has been completed, the service provider terminal 82, 88 may be used, in block 412, to generate a service completion message and transmitting the service completion message to the service coordinator server 60 via the service coordinator network 84 or another suitable communication network.

In block 414, the service coordinator server 60 may receive a service completion message that, in some embodiments, may trigger transaction information to be relayed to the payment network server 102 via the payment network 80. In some embodiments, the direct payment engine 103 at the payment network server 102 may be configured to intercept transaction information transmitted to the service coordinator server 60. In any event, in block 416, the payment network server 102 may receive transaction information corresponding to the service provided by the service provider to the customer. In block 418, the direct payment engine 103 may determine the standard payout split that may have been previously agreed upon between the particular service provider identified in the transaction information and the service coordinator. In block 420, the direct payment engine 103 may query the service coordinator server 60 as to whether surge parameters apply to the transaction. If the service coordinator server responds that no surge parameters apply, the direct payment engine 103 may, in block 426, execute a payout split based to the accounts associated with the parties to the transaction using the standard payout split. If the service coordinator server 60 instead responds that surge parameters do apply, the payment network server 102 may receive the surge parameters in block 422. In block 424, the direct payment engine 103 may apply the surge parameters to determine the surge payout split for the transaction. The direct payout engine 103 may then execute a payout split based on the surge payout split in block 426.

In block 428, the direct payment engine 103 may update the accounts associated with the parties to the transaction to reflect the payout split, and transmit the updates to the service provider terminal 82, 88 in block 430, and the service coordinator server 60 in block 432. In such embodiments, the dashboard GUIs 600, 700 illustrated in FIGS. 6 and 7 may be accessible from either the service coordinator terminals 94, 96 or the service provider terminals 82, 88 may display, in real time or in near real time, the updated fund levels as a result of the payout split.

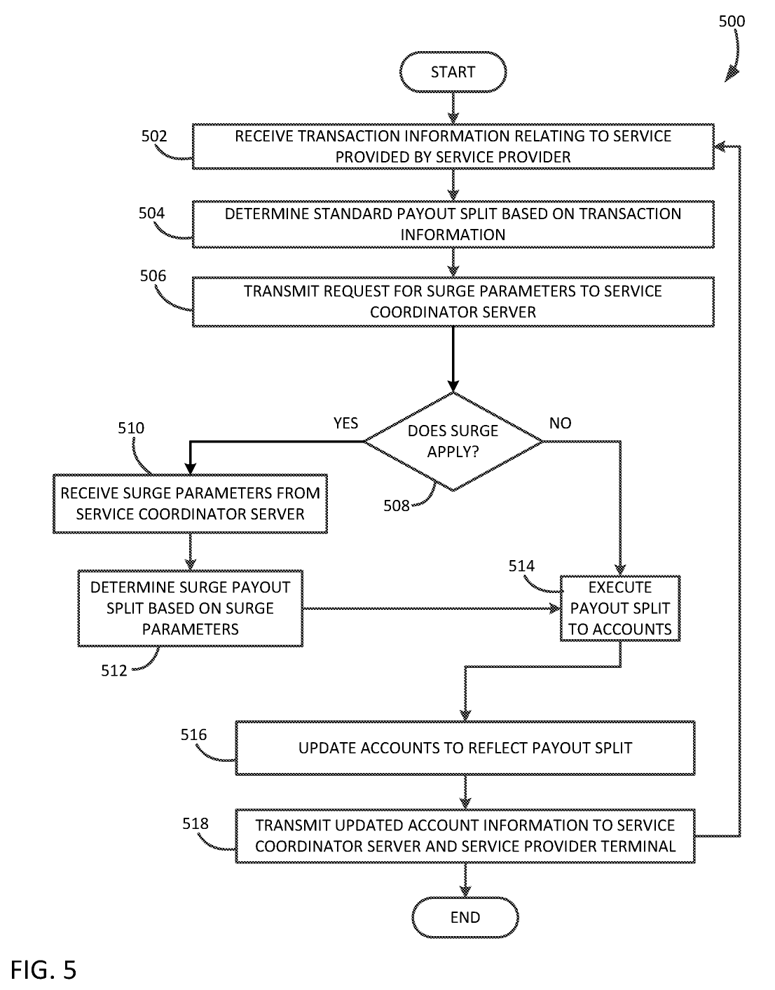

FIG. 5 shows a flow diagram 500 of another method for managing a sharing economy transaction and the payouts and payout splits associated with the transaction in accordance with example embodiments. The flow diagram may be implemented by a system or apparatus, such as, for example, payment network server 102. Each of the steps shown in the flow diagram may be repeated one or times, one or more of the steps may be modified, and one or more of the steps may be omitted. Unless otherwise noted or is plainly required by the context, the particular ordering of the blocks may also be modified. The method may be stored on a non-transitory computer readable medium as computer executable instructions. The computer executable instructions, when executed by at least one processor, may cause at least one computer or other device to perform the method one or more times. The flow diagram may begin at block 502.

In block 502, the method may include receiving transaction information relating to a service provided by a service provider. In an example, with reference to FIGS. 1 and 4, the payment network server 102 may receive transaction information (e.g., via the payment network 80) from the service coordinator server 60. In block 504, the method may include determining the standard payout split based on the transaction information received in block 502. In an example, with reference to FIGS. 1 and 4, the direct payment engine 103 on the payment network server 102 may determine the standard split that may have been previously agreed upon between the particular service provider identified in the transaction information and the service coordinator.

In block 506, the method may include transmitting a request for surge parameters to the service coordinator server 60 via the payment network 80 for determination, in block 508, as to whether surge parameters apply to the immediate transaction. If the service coordinator server 60 responds that no surge parameters apply, the method may include, in block 514, executing a payout split to the accounts associated with parties to the transaction based on the standard payout split. If the service coordinator server 60 responds that surge parameters to apply, then, in block 510, the method may include receiving the surge parameters from the service coordinator server 60 via the payment network. In block 512, the method may include determining the surge payout spilt based on the surge parameters and, in block 514, executing the payout split to the associated accounts that includes the surge payout split.

In block 516, the method may include updating the associated accounts a on the payment network server database 104 to reflect the payout split and, in block 518, transmitting the updated account information to the service coordinator server 60 and the service provider terminal 82, 88.

The method in FIG. 5 may end, may repeat one or more times, or may return to any of the preceding blocks.

Unlike in traditional markets, service coordinators in the sharing economy may not have a stable of employees providing their services at scheduled, predictable times. Instead, the service coordinators generally rely on independent service providers who may be free to participate in providing a service at any given time or not depending on whether the service provider determines providing the specific service is worth their time. For this reason, service coordinators may implement surge pricing and surge payout splits in order to provide added incentive for service providers to service customers, particularly when those services are needed the most.

The systems and methods disclosed herein make surge pricing and surge payout splits even more effective at providing incentive to service providers at peak demand times. The service providers may, in substantially real time, identify the current surge pricing or surge payout splits, and know that they will receive the additional payments associated with those surge prices and surge payout splits substantially immediately upon completing performance of the service. In some embodiments, the account balance associated with a surge payout split may be updated and available to the service coordinator or the service provider within less than one minute of sending the request for payout split, or within ten minutes, or within one hour in other embodiments, or within one day of completion in other embodiments. In some embodiments, the account is updated within similar times after the completion message. Consumers also benefit from the added supply of service providers, which may increase availability of services and potentially drive down prices as supply rises to meet the demand. Service coordinators and payment handling entities, such as payment card issuers and bands, may benefit from increased transactions due to the added incentive to provide services at times of high volume demand.

Further, the systems and methods for processing and distributing payouts generated through sharing economy services may override the routing and conventional sequence of events normally used in both the sharing economy and the electronic payment systems associated with the sharing economy. Payments reflecting the additional surge prices may be pushed directly into accounts associated with the service providers without undue delay that may traditionally occur. Additionally, the systems and methods shown and described herein are necessarily rooted in computer technology. Specifically, the real-time tracking and determination of surge parameters, surge payout splits, account fund status, and the status of provided services cannot be replicated in a non-computer context.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++ or Perl using, for example, conventional or object-oriented techniques. In some examples, the at least one processor may be specifically programmed.

The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed (or physically configured) to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, system 10 and the methods described herein may be configured to provide real-time incentive information to service providers and execute near-immediate payout splits upon service completion. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer-implemented method for managing payouts to parties to a transaction, the method comprising:
receiving, via a digital communication network, a customer request for a service transaction;
transmitting, via the digital communication network, the customer request to at least one service provider terminal;
receiving, via the digital communication network, a service completion message from the at least one service provider terminal;
determining, via one or more processors, that at least one surge parameter applies to the service transaction;
determining, via the one or more processors, a surge payout split based on the determination that at least one surge parameter applies to the service transaction;
generating, via the one or more processors, a surge payout split request based on the surge payout split;
transmitting, via a payment network, the surge payout request to a payment network server; and
receiving, via the payment network, an account update from the payment network server, the account update reflecting the surge payout split.

2. The method of claim 1, further comprising updating a graphical user interface based on the account update.

3. The method of claim 1, wherein the service completion message includes transaction information associated with the service transaction, and wherein the determination that the at least one surge parameter applies to the service transaction is based at least partly on the transaction information.

4. The method of claim 1, wherein the service completion message includes transaction information associated with the service transaction, and further comprising determining a standard payout split based on the transaction information.

5. The method of claim 4, wherein the surge payout split is different than the standard payout split.

6. The method of claim 4, wherein the surge payout split results in a higher payout to the at least once service provider than the standard payout split.

7. The method of claim 1, wherein the at least one surge parameter is associated with an increased volume of customer requests for service.

8. The method of claim 1, wherein the account update is received from the payment network server less than about ten minutes after at least one of transmitting the surge payout request to a payment network server or receiving the service completion message.

9. The method of claim 1, wherein the account update is received from the payment network server less than about one minute after at least one of transmitting the surge payout request to a payment network server or receiving the service completion message.

10. A computer-implemented method for managing payouts to parties to a transaction, the method comprising:
receiving, via a payment network, transaction information relating to a service transaction provided by at least one service provider;
transmitting, via the payment network, a request for surge parameters to a service coordinator server, the request for surge parameters being based on the transaction information;
receiving, via the payment network, at least one surge parameter from the service coordinator server;
determining, via one or more processors, a surge payout split based on the at least one surge parameter;
executing a payout split based on the surge payout split, the payout split including directing payments to an account associated with the at least one service provider; and
transmitting, via the payment network, an account update reflecting the payout split.

11. The method of claim 10, further comprising determining a standard payout split based on the transaction information.

12. The method of claim 11, wherein the surge payout split is different than the standard payout split.

13. The method of claim 11, wherein the surge payout split results in a higher payout to the at least once service provider than the standard payout split.

14. The method of claim 10, wherein the account update is transmitted from to a service provider terminal associated with the at least one service provider less than about ten minutes after receiving the transaction information.

15. An apparatus comprising:
at least one processor, and
at least one memory storing computer executable instructions that, when executed by the at least one processor, cause the apparatus at least to perform the steps of:
receiving a customer request for a service transaction;
transmitting the customer request to at least one service provider terminal;
receiving a service completion message from the at least one service provider terminal;
determining, via the at least one processor, that at least one surge parameter applies to the service transaction;
determining, via the at least one processor, a surge payout split based on the determination that at least one surge parameter applies to the service transaction;
generating, via the at least one processor, a surge payout split request based on the surge payout split;
transmitting, via a payment network, the surge payout request to a payment network server; and
receiving, via the payment network, an account update from the payment network server, the account update reflecting the surge payout split.

16. The apparatus of claim 15, wherein the computer executable instructions, when executed by the at least one processor, further cause the apparatus to update a graphical user interface based on the account update.

17. The apparatus of claim 15, wherein the service completion message includes transaction information associated with the service transaction, and wherein determination that the at least one surge parameter applies to the service transaction is based at least partly on the transaction information.

18. The apparatus of claim 15, wherein the service completion message includes transaction information associated with the service transaction, and further comprising determining a standard payout split based on the transaction information.

19. The apparatus of claim 18, wherein the surge payout split is different than the standard payout split.

20. The apparatus of claim 15, wherein the account update is received from the payment network server less than about one minute after at least one of transmitting the surge payout request to a payment network server or receiving the service completion message.
